(19) United States
(12) Patent Application Publication
(10) Pub. No.: US 2008/0122216 A1
(43) Pub. Date: May 29, 2008

(54) Device and method for a student notebook

(76) Inventors: Dena Lehrman, Efrat (IL); Michelle Berkowitz, Bet Shemesh (IL)

Correspondence Address: Pearl Cohen Zedek Latzer, LLP, 1500 Broadway, 12th Floor, New York, NY, 10036, US

(21) Appl. No.: 11/979,639

(22) Filed: Nov. 6, 2007

Related U.S. Application Data
(60) Provisional application No. 60/856,800, filed on Nov. 6, 2006.

(51) Int. Cl. B42D 1/00; B42D 15/00

(52) U.S. Cl. 281/38; 283/117

(57) ABSTRACT

A device and method for designating visibly discernible areas of notebook pages for students, to include areas on such page for writing notes, writing summaries, writing new words and writing homework preparations.

### REFERENCE TO PRIOR APPLICATIONS

This application claims benefit of U.S. provisional patent application No. 60/856,800 filed on Nov. 6, 2006 entitled A System and Method for an Organizational Notebook and Study Partner, which is incorporated into this application by reference.

### FIELD OF THE INVENTION

The present invention relates to an educational tool and method that lets students take notes, summarize, identify the main points of the lesson and organize their notebook so that is used more effectively when learning in class and for studying for tests.

### BACKGROUND OF THE INVENTION

Some students find taking notes and organizing their records of a lesson to be a daunting and confusing task. For some, lesson notes written on a blank sheet of paper may become a jumbled mass of irrelevant or minor points that are incomprehensibly recorded, and that hide the major or important points that were imparted in a lesson and which are to remembered or studied. For such students, part of learning may include practice in note taking and recording the important points imparted in a lesson.

### SUMMARY OF THE INVENTION

In some embodiments the invention may include notepaper for students having at least one page with visibly discernible areas designated on the page, where a first area is designated for writing notes of a lesson, a second area is designated for writing summarizes of notes of the lesson, and a third area is designated for completing homework about the lesson. In some embodiments, the second area may be parallel to a vertical margin of the first area, so that summaries appear parallel to notes that are summarized by the summaries. In some embodiments, the discernible areas may be shaded in varying colors. Other areas may be designated for listing words emphasized in a lesson, for listing a topic of a lesson or for marking that a review of the lesson was completed by a student.

In some embodiments, the notepaper may be shown on two sheets of paper, so that a first side of a first sheet and a second side of a second sheet which may be shown when a folio or loose-leaf is opened.

In some embodiments a notebook may include a second set of pages having printed thereon a study guide for studying about a lesson, and that may include a template having one or more spaces for filing in a response to one or more tasks posed by the study guide.

Some embodiments may include a method of preparing notepaper for students including shading a first area of the notepaper in a first color and marking the first area for note writing; shading a second area of the notepaper in a second color and marking the second area for summaries of notes, and shading a third area of the notepaper in a color other than the first color and marking the third area for listing words emphasized in a lesson.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a notebook page with designated areas in accordance with an embodiment of the invention;

FIG. 2 is a schematic diagram of a plurality of notebook pages in a folio configuration; and

FIG. 3 is a schematic diagram of test preparation page of a notebook in accordance with an embodiment of the invention.

### DETAILED DESCRIPTION OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

As used herein, the term ‘notebook’ may, in addition to its normal meanings, include a pad or other collection of pages that may or may not be gathered into a book or bound in any way. In some embodiments a page may include an electronic manifestation of a page such as one that may appear on a computer screen. In some embodiments, a page may, in addition to its regular meaning, include two or more pages that may in some embodiments open into for example a folio sheet or into a front side of a first sheet, and a back side of a previous sheet in a notebook so that when a notebook is opened in front of a student, the student is faced with two sheets, such front side and back side of the previous sheet, that are configured in accordance with an embodiment of the invention.

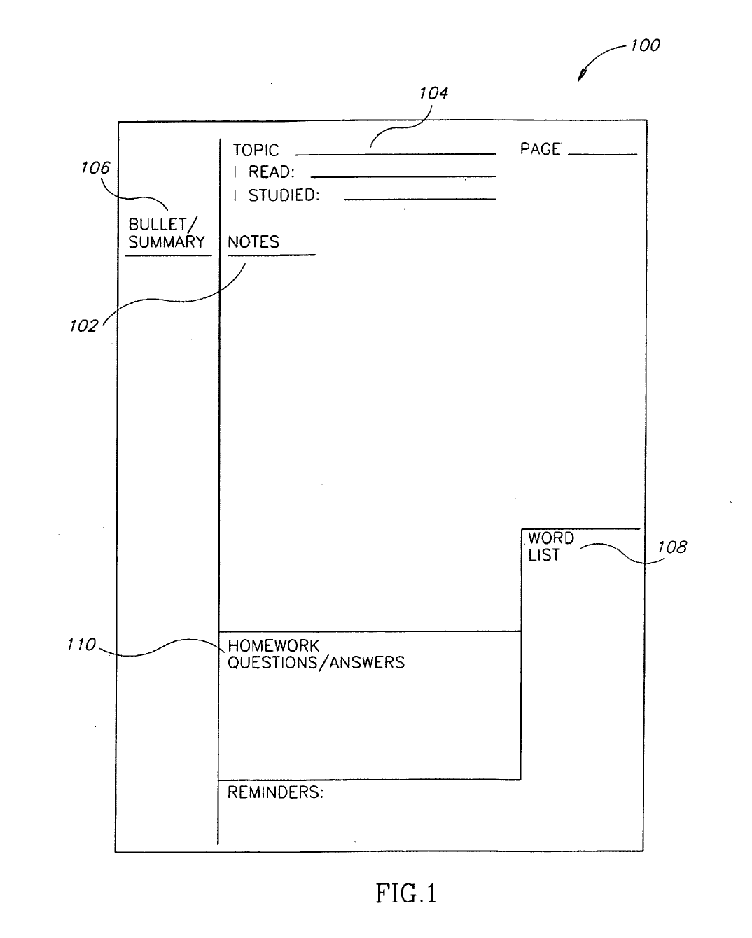

Reference is made to FIG. 1, a schematic drawing of one or more pages of a notebook in accordance with an embodiment of the invention. In some embodiments, a page 100 may include two or more shaded or colored areas or boxed off areas that provide designated spaces in which to more easily map out material to be recorded or written. The notebook or page 100 within the notebook may include designated areas on the page for a student to write or record different categories of information. The designated areas may be shaded or colored or boxed off in different forms for ease of recognition by the student or other user or reader. For example, a top area 104 or areas of the page may include a space for a lesson number or date, a title and a source of the information being recorded, such as a book, teacher, speaker, slide show or other source of data. A lower or other area 102 may include for example a center area where the student or user may take general notes on the lesson or topic. The main area 102 may be in the center of the page and may be wider than other areas to allow ease of writing and focus by a user. The main area 102 may be rectangular, square or of other shape.

A side area 106 surrounding the center, for example on the left side may be narrower than the center and may include a vertical area for summary words or headings or notes on the topic or information in the main or center area. The side area may be marked with ‘Summary’ so that the student recognizes that this area is for summary notes or bullets that may summarize the main area. Another area 108 such as another side area may be used for recording new words, dates, equations or phrases that are learned during the lesson.

Another area 110 may be designated for recording questions or points that were not clear to the student during the lesson.

Another area may be designated for vocabulary words. Another area may be designated for homework or problems that were assigned in the course of the lesson.

One or more of the areas may be shaded in different colors for ease of use and recognition.

In some embodiments, the location or designation of areas on one or more page may be varied.

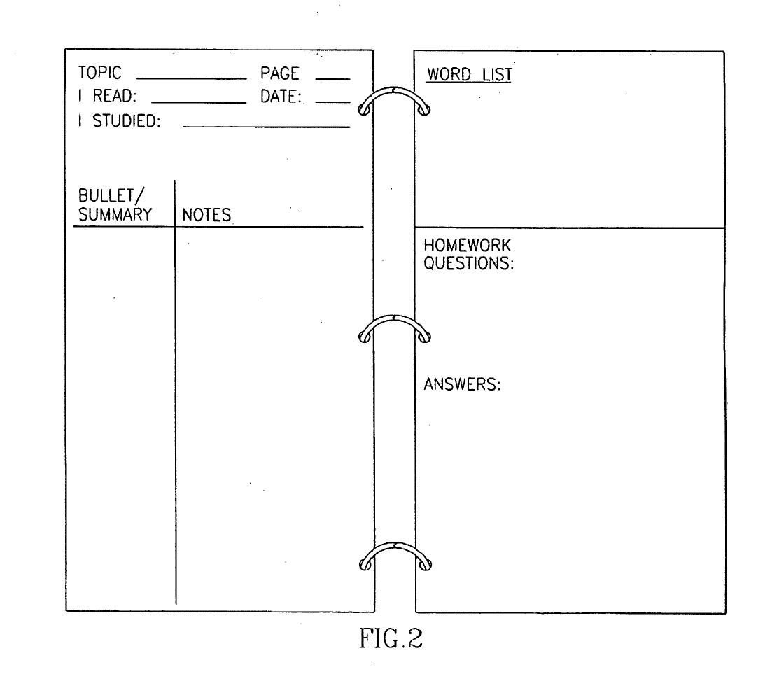

Reference is made to FIG. 2, a schematic diagram of notebook pages in a folio configuration. In some embodiments, the notepaper may be configured on two sheets of paper, such that the designated areas are distributed on a first side of a first sheet and a second side of a second sheet, so that said first side and said second side face the user when the notebook that may hold the notepaper is fully opened or spread out in front of a student user.

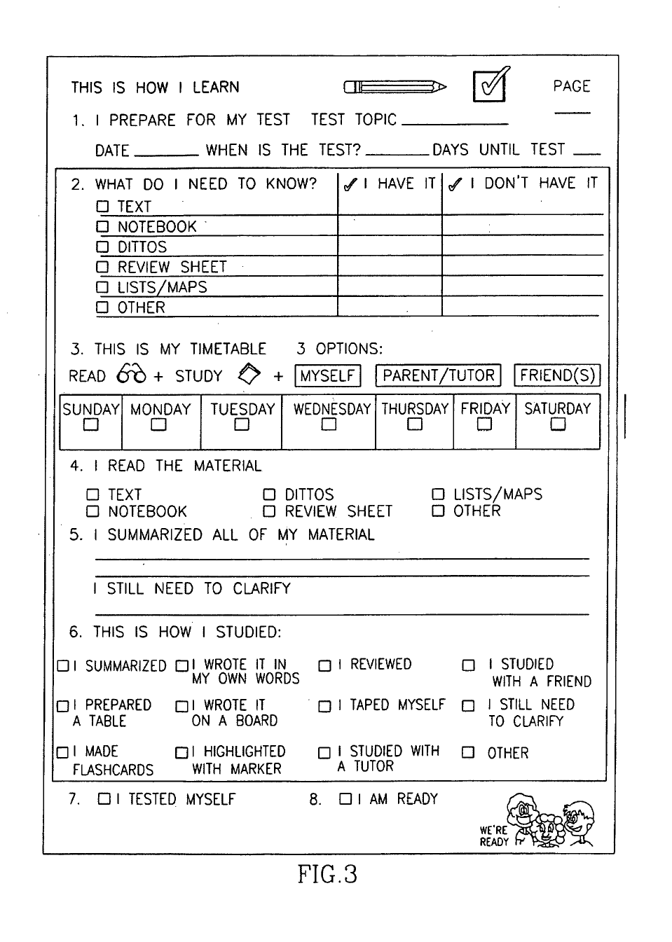

Reference is made to FIG. 3, a schematic diagram of test preparation page of a notebook in accordance with an embodiment of the invention. Study partner guides may be provided in the back or elsewhere in the notebook to help students identify what they need to know for a test, plan a study schedule, summarize the material and address various modalities of studying for the test. The study partner may include a step by step guide that may help the student learn how to prepare and study for a test. It may enable teachers and parents to have a greater understanding as to where the student is having difficulty in preparation for a test or the tasks that remain to be done for preparation.

The study guide may include an area for a date of a test, a listing of the lessons to be learned for the test, an indication of the material to be studied, a check list of the material studied or reviewed and a schedule for the process of studying. Other organizational tools may be included in the notebook.

In some embodiments, printed pages that include an embodiment of the invention may be included in a pad of paper, whose pages may be torn out or otherwise separated for insertion into for example a loose-leaf or other organizer.

Some embodiments may include a method for preparing notepaper for students, such as for example students in grade school, where the notepaper includes several visibly discernible areas that may be printed on one or more pages, and where one or more of such areas are designated for writing notes of a lesson, such as notes about what a teacher discussed in a class. A second area may be designated for writing summarizes of the notes of the lesson. This second area may for example occupy an area along for example a left margin of a page and may run parallel to the first area so that summaries written in this margin area may appear along side or parallel to the written notes that are summarized. A third area of the page may be designated for questions and/or answers or for completing homework about the lesson that is the subject of the notes. One or more of such areas may be marked and or shaded on one or more sheets of paper in a notebook.

In some embodiments, the marking of areas may include shading of the areas in different colors or varying shades, and the designation of the areas may be shown with titles of the areas such as NOTES, SUMMARIES, BULLETS, HOMEWORK, DATE, TOPIC, WORDS. Other designations may be used. In some embodiments one or more areas may be designated for new words learned or emphasized in the lesson, a topic of the lesson. In some embodiments, an area may be designated wherein a student can indicate with for example a check mark that the student has for example reviewed or understood the material on the page.

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention.

We claim:

1. Notepaper for students comprising:
at least one page having a plurality of visibly discernible areas designated on said at least one page,
a first of said areas designated for writing notes of a lesson, a second of said areas designated for writing summarizes of said notes of said lesson, and
a third of said areas designated for completing homework about said lesson.

2. The notepaper as in claim 1, wherein said second of said areas is parallel to a vertical margin of said first area, so that said summaries appear parallel to a note of said notes summarized by said summaries.

3. The notepaper as in claim 1, wherein said visibly discernible areas comprise a plurality of colors, shading at least one of said visibly discernible areas.

4. The notepaper as in claim 1, comprising a fourth of said areas designated for listing words emphasized in said lesson.

5. The notepaper as in claim 1, comprising a fifth of said areas designated for listing a topic of said lesson.

6. The notepaper as in claim 1, comprising a sixth of said areas designated for receiving an indication of a completed review of said lesson by a student.

7. The notepaper as in claim 1, comprising two sheets of paper, wherein said plurality of areas are distributed on a first side of a first sheet and a second side of a second sheet, so that said first side and said second side face a user when a notebook housing said notepaper is opened in front of said user.

8. A notebook for students comprising:
a plurality of page designs for pages of said notebook,
a first of said plurality of page designs having a plurality of visibly discernible areas designated on a plurality of pages of said notebook, wherein
a first of said areas is designated for writing notes of a lesson,
a second of said areas is designated for writing summarizes of said notes of said lesson, and
and a third of said areas is designated for completing homework about said lesson; and
a second of said plurality of page designs having printed thereon a study guide for studying said lesson, said template having a space thereon for filling in a response to a task posed by said study guide.

9. The notebook as in claim 8, wherein said second of said areas is parallel to a vertical margin of said first area, so that said summaries appear parallel to a note of said notes summarized by said summaries.

10. The notebook as in claim 8, wherein said visibly discernible areas comprise a plurality of colors shading said areas.

11. The notebook as in claim 8, wherein said first of said plurality of page designs comprises two sheets of paper, wherein said plurality of areas are distributed on a first side of a first sheet and a second side of a second sheet, so that said first side and said second side face a user when a notebook housing said notepaper is opened in front of said user.

12. A method of preparing notepaper for students comprising:
shading a first area of said notepaper in a first color and marking said first area for note writing;
shading a second area of said notepaper in a second color and marking said second area for summaries of said notes;
shading a third area of said notepaper in a color other than said first color and marking said third area for listing words emphasized in a lesson.

13. The method as in claim 12, comprising shading a fourth area of said notepaper in a color other than said first color and marking said fourth area for preparation of homework about said lesson.

14. The method as in claim 12, comprising distributing said shaded first area, second area and third area over on a first side of a first sheet and a second side of a second sheet, so that said first side and said second side face a user when a notebook housing said notepaper is opened in front of said user.
